(19) United States
(12) Patent Application Publication
(10) Pub. No.: US 2026/0065678 A1
(43) Pub. Date: Mar. 5, 2026

(54) SYSTEMS, APPARATUSES, AND METHODS FOR DETECTING HAZARDOUS EVENTS

(71) Applicant: STUDSVIK INC., Wilmington, NC (US)

(72) Inventors: David D. Heilman, Geneseo, IL (US); Benjamin Youman, Davis Junction, IL (US)

(21) Appl. No.: 18/820,872

(22) Filed: Aug. 30, 2024

(51) Int. Cl. G06V 20/52; G06V 10/58; G06V 10/70; G06V 20/40

(52) U.S. Cl. CPC G06V 20/52; G06V 10/58; G06V 10/70; G06V 20/44

(57) ABSTRACT

An apparatus may include a one or more sensor devices configured to capture data of an environment, such as infrared data and images, and a computing device in communication with the one or more sensor devices. The computing device may be configured to receive the data, determine one or more hazardous events based on analyzing the data, and cause one or more indications associated with the one or more hazardous events to be output.

### BACKGROUND

Hot work activities includes any work that involves drilling, cutting, grinding, welding, soldering, burning, melting of flammable substances, and other spark-producing activities which can often be a source of complex and costly fires. For example, it has been noted that hot work has been the source of a significant amount of fires, split between homes and business, resulting in millions of dollars in losses and business interruptions. A fire and smoke detection system is an important safety tool used in hazardous or exposed environments, such as environments involving hot work activities. Degraded fire protection systems present increase risk for fire events and necessitate compensatory regulatory actions often requiring solutions that are timely. Fire and smoke detection are also important in environments with low traffic, like warehouses, where fire or smoke may not be noticed until it is too late to stop. Conventional video-based fire and smoke detection systems are often in fixed locations, such as mounted to a wall, provide low resolution video, have limited visibility, and are difficult to monitor and fail to comply with regulatory fire protection code standards. These conventional systems are also highly inaccurate, resulting in false positives and false-negatives that undermine trust in the systems. Moreover, the failure or degradation of conventional fire protection systems often lead to regulatory actions requiring extensive compensatory actions that require resources and expenditures.

### SUMMARY

It is to be understood that both the following general description and the following detailed description are exemplary and explanatory only and are not restrictive.

Methods, apparatuses, and systems for detecting hazardous events based on data of an environment captured by one or more sensor devices are described. An apparatus may include a one or more sensor devices configured to capture the data of the environment and a computing device in communication with the one or more sensor devices. The computing device m be configured to receive the data, detect one or more hazardous events based on analyzing the data, and cause one or more indications associated with the detected one or more hazardous events to be output.

In an embodiment, are apparatuses comprising one or more sensor devices configured to capture data associated with an environment in a field of view of the one or more sensor devices, and output the data associated with the environment in the field of view of the one or more sensor devices and information associated with the data, computing device in communication with the one or more sensor devices, wherein the computing device is configured to receive the data associated with the environment in the field of view of the one or more sensor devices and the information associated with the data, determine, based on the data, one or more hazardous events associated with the environment and hazardous event information associated with the one or more hazardous events, and cause, based on the determination of the one or more hazardous events, output of one or more indications associated with the one or more hazardous events and the information.

In an embodiment, are methods comprising receiving, by a computing device, from one or more sensor devices, data associated with an environment in a field of the one or more sensor devices and information associated with the data, determining, based on the one or more images, one or more hazardous events associated with the environment and hazardous event information associated with the one or more hazardous events, and causing, based on the determination of the one or more hazardous events, output of one or more indications associated with the one or more hazardous events and the information.

This summary is not intended to identify critical or essential features of the disclosure, but merely to summarize certain features and variations thereof. Other details and features will be described in the sections that follow.

### BRIEF DESCRIPTION OF THE DRAWINGS

In order to provide understanding techniques described, the figures provide non-limiting examples in accordance with one or more implementations of the present disclosure, in which:

FIG. 1 shows an example hazardous event detection system;

FIG. 2 shows an example system environment;

FIG. 3 shows an example system environment;

FIGS. 4A-4B show example user interfaces;

FIGS. 5A-5D show example user interfaces;

FIG. 6 shows an example user interface;

FIG. 7 shows an example user interface; and

FIG. 8 shows a flowchart of an example method.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, the methods and systems may take the form of a computer program product on a computer-readable storage medium (non-transitory) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a computer (e.g., a special purpose computer), or other programmable data processing apparatus to produce a machine, such that the processor-executable instructions which execute on the computer or other programmable data processing apparatus create a device for implementing the functions specified in the flowchart block or blocks.

This detailed description may refer to a given entity performing some action. It should be understood that this language may in some cases mean that a system (e.g., a computer) owned and/or controlled by the given entity is actually performing the action.

Blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

The method steps recited throughout this disclosure may be combined, omitted, rearranged, or otherwise reorganized with any of the figures presented herein and are not intend to be limited to the four corners of each sheet presented.

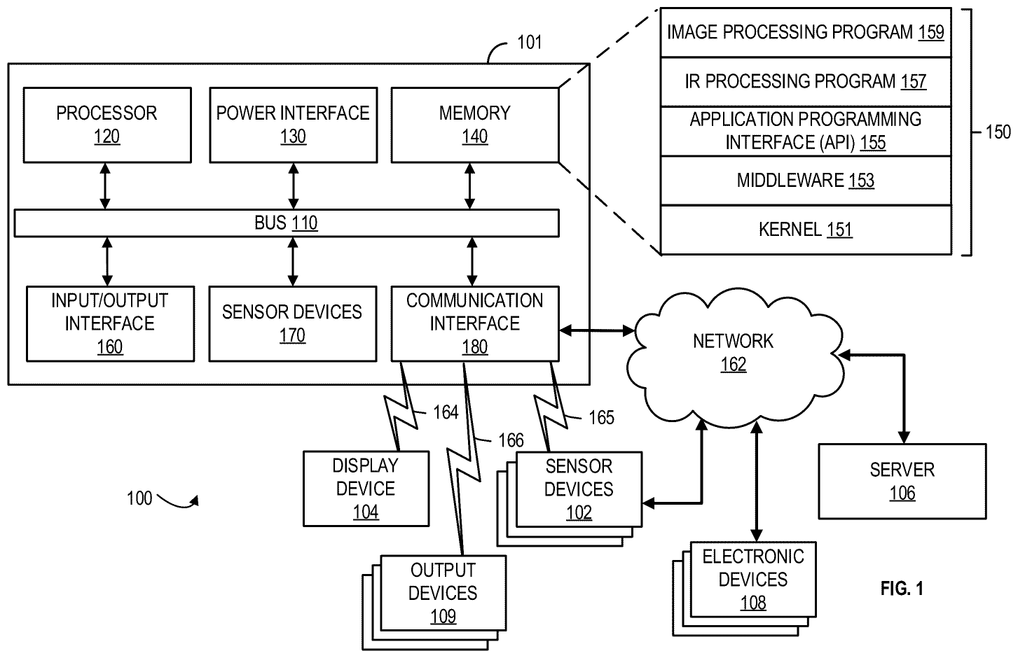

FIG. 1 shows an example system 100 for detecting hazardous events based on data captured by one or more sensor devices (e.g., sensor devices 102) associated with an environment in a field of view of the one or more sensor devices. For example, the one or more sensor devices may receive data associated with an environment in a field of view of the one or more sensor devices and the data to a computing device (e.g., computing device 101). The computing device may analyze the data to determine (e.g., detect) one or more hazardous events associated with the environment. Based on the determination of the one or more hazardous events, the computing device may cause one or more indications associated with the one or more hazardous events to be output. The system 100 may include a computing device 101, one or more sensor devices 102, a display device 104, a server 106, one or more electronic devices 108, and one or more output devices 109. As an example, the system 100 may be configure to be compliant with National Fire Protection Association (NFPA) rules/standards. In an example, the computing device 101 may be configured to receive and process (e.g., analyze) data associated with an environment captured by the one or more sensor devices 102 (e.g., infrared (IR) data, one or more images, one or more video streams, etc.). The computing device 101 may be in communication with the one or more sensor devices 102, the server 106, and/or the one or more electronic devices 108 via a network (e.g., network 162).

The computing device 101 may include a bus 110, one or more processors 120, a power interface 130 (e.g., power system), a memory 140, an input/output interface 160, one or more sensor devices 170, and a communication interface 180. In certain examples, the computing device 101 may omit at least one of the aforementioned elements or may additionally include other elements. The computing device 101 may comprise a tablet computer, a laptop computer, a mobile device, a desktop computer, and the like. In an example, the computing device 101 may be housed within an enclosure. The enclosure may be compliant with NFPA rules/standards. For example, the enclosure may be constructed out of metal, cast metal, fire resistant plastic, or any suitable material. For example, the enclosure may be water proof, fire resistant to chemical exposure, and so forth, such that the computing device 101 may be utilized during a hazardous event (e.g., fire, flame, chemical spill, etc.) and continue to operate normally.

The bus 110 may comprise a circuit for connecting the bus 110, the one or more processors 120, the power interface 130, the memory 140, the input/output interface 160, the one or more sensor devices 170, and/or the communication interface 180 to each other and for delivering communication (e.g., a control message and/or data) between the bus 110, the one or more processors 120, the power interface 130, the memory 140, the input/output interface 160, the one or more sensor devices 170, and/or the communication interface 180.

The one or more processors 120 may include one or more of a Central Processing Unit (CPU), an Application Processor (AP), or a Communication Processor (CP). The one or more processors 120 may control, for example, at least one of the bus 110, the power interface 130, the memory 140, the input/output interface 160, the one or more sensor devices 170, and/or the communication interface 180 of the computing device 101 and/or may execute an arithmetic operation or data processing for communication. As an example, the one or more processors 120 may implement logic (e.g., hardware, software, firmware, etc.) stored in the memory 140 to cause the computing device 101 receive and analyze data captured by the one or more sensor devices 102 of an environment to determine one or more hazardous events in the environment. The processing (or controlling) operation of the one or more processors 120 according to various embodiments is described in detail with reference to the following drawings.

The power interface 130 (e.g., power system) may be configured to interface with an external power source (e.g., AC power source) and/or one or more batteries (e.g., DC power source) for supplying back-up power in the event there is a loss of power from the external power source. For example, the batteries may be built-in or integral batteries to the power interface 130 of the computing device 101. As an example, the one or more batteries may be configured to operate in an uninterruptable power supply (UPS) mode or a in a stand-alone battery mode. For example, while in UPS mode, when the external AC power source is connected, the external power source may supply power to the computing device 101 in addition to charging the one or more batteries via the power interface 130. However, the one or more batteries may supply back-up power in the event the computing device 101 is no longer receiving power from the external power source. In an example, the computing device 101 may detect a loss of power from the one or more batteries. Based on detecting the loss of power from the one or more batteries, the computing device 101 may cause the one or more output devices 109 to output one or more warning signals.

The processor-executable instructions executed by the one or more processors 120 may be stored and/or maintained by the memory 140. The memory 140 may include a volatile and/or non-volatile memory. The memory 140 may include random-access memory (RAM), flash memory, solid state or inertial disks, or any combination thereof. As an example, the memory 140 may include an Embedded MultiMedia Card (eMMC). The memory 140 may store, for example, a command or data related to at least one of the bus 110, the one or more processors 120, the power interface 130, the memory 140, the input/output interface 160, the one or more sensor devices 170, and/or the communication interface 180 of the computing device 101. According to various examples, the memory 140 may store software and/or a program 150 or may comprise firmware. For example, the program 150 may include a kernel 151, a middleware 153, an Application Programming Interface (API) 155, an infrared (IR) processing program 157, and/or an image processing program 159, and/or the like, configured for controlling one or more functions of the computing device 101 and/or an external device (e.g., the sensor devices 102, the display device 104, or the electronic device 108). At least one part of the kernel 151, middleware 153, or API 155 may be referred to as an Operating System (OS). The memory 140 may include a computer-readable recording medium (e.g., a non-transitory computer-readable medium) having a program recorded therein to perform the methods according to various embodiments by the one or more processors 120. In an example, the memory 140 may store the data (e.g., IR data, images, videos, etc.) received from the sensor devices 102, including information associated with the data.

The kernel 151 may control or manage, for example, system resources (e.g., the bus 110, the one or more processors 120, the memory 140, etc.) used to execute an operation or function implemented in other programs (e.g., the middleware 153, the API 155, the IR processing program 157, or the image processing program 159). Further, the kernel 151 may provide an interface capable of controlling or managing the system resources by accessing individual elements of the computing device 101 in the middleware 153, the API 155, the IR processing program 157, or the image processing program 159.

The middleware 153 may perform, for example, a mediation role, so that the API 155, the IR processing program 157, and/or the image processing program 159 can communicate with the kernel 151 to exchange data. Further, the middleware 153 may handle one or more task requests received from the IR processing program 157, and/or the image processing program 159 according to a priority. For example, the middleware 153 may assign a priority of using the system resources (e.g., the bus 110, the one or more processors 120, or the memory 140) of the computing device 101 to at least one of the IR processing program 157, and/or the image processing program 159. For example, the middleware 153 may process the one or more task requests according to the priority assigned to at least one of the application programs, and thus, may perform scheduling or load balancing on the one or more task requests.

The API 155 may include at least one interface or function (e.g., instruction), for example, for file control, window control, video processing, and/or character control, as an interface capable of controlling a function provided by the IR processing program 157, and/or the image processing program 159 in the kernel 151 or the middleware 153.

As an example, the IR processing program 157, and/or the image processing program 159 may be independent of each other or integrally combined, in whole or in part.

The IR processing program 157 may include logic (e.g., hardware, software, firmware, etc.) that may be implemented to cause the computing device 101 to analyze the IR data (e.g., IR images, etc.) received from the one or more sensor devices 102. The one or more sensor devices 102 may comprise one or more infrared detection devices and/or one or more camera devices. As an example, the sensor devices 102 may comprise a camera device included (e.g., embedded) within an infrared detection device configured as a single device. For example, the infrared detection device device may be configured to capture infrared data of the environment and the camera device may capture images/video of the environment. As an example, each sensor device 102 may be housed within a NFPA-compliant enclosure. For example, the enclosure may be constructed out of metal, cast metal, fire resistant plastic, or any suitable material. For example, the enclosure may be water proof, fire resistant to chemical exposure, and so forth, such that the sensor devices 102 may be utilized during a hazardous event (e.g., fire, flame, chemical spill, etc.) and continue to operate normally. The sensor devices 102 may be configured to capture data (e.g., IR data) of an environment in a field of view of the sensor devices 102 and output/send data and information associated with the data to the computing device 101. As an example, the environment may comprise one or more hot work activities (e.g., drilling, cutting, grinding, welding, soldering, burning, melting of flammable substances, other spark-producing activities, and the like). The field of view may comprise a 90-degree horizontal field of view and a 75-degree vertical field of view from a nose of the one or more sensor devices 102. The information associated with the data may comprise one or more of a start time, a stop time, a duration, an image, an age (e.g., duration from when image was captured), or a location (e.g., camera/sensor location and/or camera/sensor identifier).

The IR processing program 157 may cause the computing device 101 to analyze the IR data received by the one or more sensor devices 102 (e.g., infrared detection devices) and determine/detect flames or fires (e.g., hazardous events) in the environment. As an example, the IR processing program 157 may include FM-approved, NFPA algorithms (e.g., artificial intelligence (AI) embedded video analytics) for monitoring the data captured of the environment for detecting hazardous events (e.g., flames/fires) in the environment. For example, infrared characteristics (e.g., spectral emissions) of one or more flames in the environment may be identified based on the IR data captured by the one or more sensor devices 102. The flames/fires may be determined/detected in the environment based on identifying the infrared characteristics (e.g., spectral emissions) of the flames in the environment. In an example, the IR processing program 157 may cause the computing device 101 to determine one or more images (e.g., captured by one or more camera devices) before any of the detected flames or fires and one or more images (e.g., captured by one or more camera devices) after any of the detected flames. The one or more images before the detected flames or fires may be associated with a preset time interval before each detection and the one or more images after the detected flames or fires may be associated with a preset time interval after each detection. As an example, a user may provide input to set the time interval for determining the one or more images before each detection and a time interval for determining the one or more images after each detection. The images before, during, and after the detected flames or fires may be saved for replaying at a later time (e.g., via the display device 104, the electronic devices 108, etc.).

Based on determining/detecting flames or fires in the environment, the IR processing program 157 may cause the computing device 101 to output one or more indications associated with the detected flames or fires and the information associated with the data. In one example, the computing device 101 may output one or more notifications of the detected flames or fires. In another example, the computing device 101 may output the one or more images associated with the detected flames or fires, information associated with the detected flames or fires (e.g., hazardous event information), and the information associated with the data. The information associated with the detected flames or fires may comprise one or more of an indication of each detected flame or fire, or location information (e.g., a building, a location within the building including building floor, a camera that made the detection, etc.) associated with the detected fires or flames. As an example, the information associated with the detected flames or fires and the information associated with the data may be overlaid onto the images associated with the detected flames or fires.

A display device 104, one or more electronic devices 108 (e.g., user devices such as mobile devices, smart phones, tablet computers, desktop computers, and the like), and/or one or more output devices 109 (e.g., audio output devices or speakers, and/or lighting devices) may be in communication with the computing device 101. The computing device 101 may send the one or more indications to the display device 104, the one or more electronic devices 108, and/or the output devices 109. In an example, the display device 104 and/or the one or more electronic devices 108 may display the one or more notifications associated with the detected flames or fires. For example, the display device 104 and/or one or more electronic devices 108 may display the one or more images associated with the detected flames or fires, the information associated with the detected flames or fires, and/or the information associated with the data associated with the detected flames or fires. In an example, the display device 104 and/or one or more electronic devices 108 may display the one or more images associated with the detected flames or fires overlaid with the information associated with the detected flames or fires and/or the information associated with the data. In an example, the output devices 109 (e.g., audio output devices or lighting devices) may output one or more warning signals associated with, or based on, the detected flames or fires. For example, the one or more warning signals may comprise one or more of an audio warning signal via one or more audio output devices or a lighting signal via one or more lighting devices.

As an example, the one or more infrared detection devices may comprise one or more triple infrared (IR3) detection devices. The sensor devices 102 (e.g., the IR3 detection devices) may be configured to process one or more IR data (e.g., IR images, etc.) to detect flames or fires in the environment in the field of view of the sensor devices 102 and send an indication of the detected flames or fires to the computing device 101. In an example, the sensor devices 102 may include IR image processing logic to cause the sensor devices 102 to detect the flames or fires in the captured data. For example, the infrared characteristics (e.g., spectral emissions) of one or more flames in the environment may be identified. The flames/fires may be determined/detected in the environment based on identifying the infrared characteristics (e.g., spectral emissions) of the flames in the environment. The sensor devices 102 may be configured to output/send one or more images associated with the detected flames or fires and the information associated with the data to the computing device 101. The computing device 101 may receive the images associated with the detected flames or fires and the information associated with the data and output the images, the information associated with the detected flames or fires, and/or the information associated with the data.

The image processing logic 159 may include logic (e.g., hardware, software, firmware, etc.) that may be implemented to cause the computing device 101 to analyze the images (e.g., video streams) being received from the one or more sensor devices 102 (e.g., one or more camera devices). For example, the image processing logic 159 may cause the computing device 101 to implement video processing analytics (e.g., one or more artificial intelligence algorithms or one or more machine learning models) to analyze the images received from the one or more sensor devices 102 and determine/detect one or more hazardous events in the environment. As an example, the artificial intelligence algorithms and/or the machine learning models may comprise computer vision for processing/analyzing the one or more images to determine the one or more hazardous events. For example, the image processing program 159 may include FM-approved, NFPA algorithms (e.g., AI embedded video analytics) for monitoring the image information (e.g., information associated with the captured data from the sensor devices 102) for detecting hazardous events (e.g., flames/fires) in an environment. The image information may comprise one or more of a start time, a stop time, a duration, an image, an age, or a location. For example, the image processing program 159 may implement video analytics to monitor light levels of camera pixels for an organized group of pixels having a light level change to determine whether the light levels of the pixels are associated with an organized pattern consistent with smoke patterns in a rising plume. The one or more hazardous events may comprise one or more of smoke, flames, visible vapor, steam, oil mist, oil leaks, fuel leaks, reflected flames, explosions, fireballs, motion, and the like. For example, the image processing logic 159 may cause the computing device 101 to the detect and identify the one or more hazardous events in each image associated with the one or more hazardous events. In an example, the image processing logic 159 may cause the computing device 101 to determine one or more detection zones associated with each image of the one or more images for detecting the one or more hazardous events in the environment. The computing device 102 may determine whether any hazardous events are detected in any of the designated detection zones of each image. In an example, the image processing logic 159 may cause the computing device 101 to determine one or more images before each hazardous event of the one or more hazardous events and one or more images after each hazardous event. The one or more images before each hazardous event may be associated with a preset time interval before each hazardous event and the one or more images after each hazardous event may be associated with a preset time interval after each hazardous event. As an example, a user may provide input to set the time interval for determining the one or more images before each hazardous event and the time interval for determining the one or more images after each hazardous event.

Based on determining/detecting the one or more hazardous events in the environment, the image processing program 159 may cause the computing device 101 to output one or more indications associated with the detected hazardous events and the image information associated with the captured images. In one example, the computing device 101 may output one or more notifications of the detected hazardous events. In another example, the computing device 101 may output the one or more images associated with the detected hazardous events, hazardous event information associated with each detected hazardous event, and the image information. The hazardous event information may comprise one or more of an indication of each hazardous event (e.g., identification of the hazardous event) of the one or more hazardous events or location information (e.g., a building, a location within the building, a camera that made the detection, etc.) associated with each hazardous event. As an example, the hazardous event information and the image information may be overlaid onto the images associated with the detected hazardous events.

As an example, the computing device 101 may send the one or more indications to the display device 104, the one or more electronic devices 108, and/or the output devices 109. In an example, the display device 104 and/or one or more electronic devices 108 may display the one or more notifications associated with the detected hazardous events. For example, the display device 104 and/or one or more electronic devices 108 may display the one or more images associated with the detected hazardous events, the hazardous event information, and/or the image information. In an example, the display device 104 and/or one or more electronic devices 108 may display the one or more images associated with the detected hazardous events overlaid with the hazardous event information and/or the image information. For example, the display device 104 and/or the one or more electronic devices 108 may indicate locations in each image of each of the detected hazardous events. In an example, the output devices 109 (e.g., audio output devices or lighting devices) may output one or more warning signals associated with, or based on, the detected hazardous events. For example, the one or more warning signals may comprise one or more of an audio warning signal via one or more audio output devices or a lighting signal via one or more lighting devices.

In an example, one of the output devices 109 may include a fire alarm control panel of a fire alarm system. The computing device 101 may be configure to interface with the fire alarm control panel (e.g., via UL fire components of a building's existing fire alarm system) for outputting the one or more indications. For example, the computing device 101, including the sensor devices 102, may be configured to augment or replace a building's existing fire alarm system (e.g., existing fire protection equipment of a building). For example, the computing device 101, including the sensor devices 102, may be configured to take over the functions of the existing fire alarm system in scenarios wherein the existing fire alarm system is degraded or inoperable. As an example, the computing device 101 may be configured to include a UL-qualified fire panel interface (e.g., alarm and fault relay dry contacts) for communicating with the fire alarm control panel and outputting the one or more indications, including location information, to the alarm control panel. The fire alarm control panel may provide an interface for outputting the indications of the hazardous events to a user of the fire alarm control panel. In addition, the computing device 101 may cause the fire alarm control panel to control the fire alarm system to output one or more warning signals (e.g., audio and/or lighting warning signals) associated with, or based on, the detected hazardous events.

In an example, the one or more sensor devices 102 may include one or more sensors (e.g., accelerometers and the like) for determining/detecting one or more indications of tampering associated with the one or more sensor devices 102. For example, the sensor devices 102 may utilize one or more accelerometers to determine an orientation of the sensor devices 102 to determine whether the sensor devices 102 are monitoring the correct area or need to be repositioned. Based on determining the one or more indications of tampering, the one or more sensor devices 102 may output one or more notifications associated with the one or more indications of tampering associated with the one or more sensor devices 102.

The input/output interface 160 may include an interface for delivering an instruction or data input from a user (e.g., an operator of the computing device 101) or from a different external device (e.g., display device 104 and/or electronic devices 108) to the different elements of the computing device 101. Further, the input/output interface 160 may output an instruction or data received from one or more elements of the computing device 101 to one or more external devices (e.g., sensor devices 102, display device 104, electronic devices 108, and/or output devices 109).

The one or more sensor devices 170 may comprise one or more of a temperature sensor, a humidity sensor, a light sensor, a smoke sensor, a carbon monoxide sensor, a gas sensor, a chemical sensor, and/or a radiation sensor. The one or more sensor devices 170 may be configured to determine any number of characteristics of an environment in proximity to the computing device 101 (e.g., the environment around the computing device 101, the ambient environment, etc.), especially since the computing device 101 may be located in an environment separate than the sensor devices 102. The computing device 101 may be configured to utilize the one or more sensor devices 170 to determine one or more characteristics of the environment in proximity to the computing device 101. For example, the computing device 101 may receive data from the one or more sensor devices 170 and determine one or more characteristics of the environment based on the data. The computing device 101 may be configured to provide data measured from the one or more sensor devices 170 and/or the one or more determined characteristics to one or more external devices (e.g., display device 104, electronic devices 108, server 106, etc.). As an example, the one or more sensor devices 170 may comprise a temperature sensor for monitoring a temperature of the environment in proximity to the computing device 101. The computing device 101 may be configured to provide the data from the temperature sensor to one or more external devices (e.g., display device 104, electronic devices 108, server 106, etc.), and/or the computing device 101 may send a notification to the one or more external devices to indicate, based on the data received from the temperature sensor, that the temperature of the environment in proximity to the computing device 101 has reached a threshold (e.g., that the temperature indicates a fire nearby). This data may be compared with one or more indications associated with the data (e.g., IR data and/or images/video of the environment in proximity to the computing device 101) captured by the one or more sensor devices 102 to further confirm whether there is a fire in proximity to the computing device 101.

The communication interface 180 may establish, for example, communication between the computing device 101 and one or more external devices (e.g., the sensor devices 102, the display device 104, the electronic devices 108, the output devices 109, or the server 106). In an example, the communication interface 180 may communicate with one or more of the external devices (e.g., the sensor devices 102, the electronic devices 108, and/or the server 106) by being connected to a network 162 through wireless communication or wired communication. The network 162 may include, for example, at least one of a telecommunications network, a computer network (e.g., LAN or WAN), the Internet, and/or a telephone network.

The communication interface 180 may be configured to communicate with one or more of the external devices (e.g., the sensor devices 102, the display device 104, and/or the output devices 109) via a wired communication interface 164, 165, 166 or a wireless communication interface 164, 165, 166. In an example, the wired communication may include, for example, at least one of Universal Serial Bus (USB), High Definition Multimedia Interface (HDMI), Recommended Standard-232 (RS-232), power-line communication, Plain Old Telephone Service (POTS), and the like. In an example, as a cellular communication protocol, the wireless communication interface 164, 165, 166 may use at least one of Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. In an example, the wireless communication interface 164, 165, 166 may be configured to use a near-distance communication 164, 165, 166. The near-distance communication interface 164, 165, 166 may include for example, at least one of Wireless Fidelity (WiFi), Bluetooth, Bluetooth Low Energy (BLE), Near Field Communication (NFC), Global Navigation Satellite System (GNSS), and the like. According to a usage region or a bandwidth or the like, the GNSS may include, for example, at least one of Global Positioning System (GPS), Global Navigation Satellite System (GLONASS), BeiDou Navigation Satellite System (BDS), Galileo, the European global satellite-based navigation system, and the like. Hereinafter, the “GPS” and the “GNSS” may be used interchangeably in the present document. In an example, the communication interface 180 may include or be communicably coupled to a transmitter, receiver and/or transceiver for communication with one or more of the external devices (e.g., the sensor devices 102, the display device 104, the electronic devices 108, the output devices 109, or the server 106).

The display device 104 may comprise one or more of a television, an audio/video monitor, a streaming device, and the like. The display device 104 may include various types of displays, for example, a Liquid Crystal Display (LCD) display, a Light Emitting Diode (LED) display, an Organic Light-Emitting Diode (OLED) display, a MicroElectroMechanical Systems (MEMS) display, or an electronic paper display. In an example, the display device 104 may be configured as a part of the computing device 101 or as a separate external device. In an example, the display device 104 may include audio output devices (e.g., speakers) for outputting audio received from the computing device 101. In an example, the display device 104 may be in communication with earphones (e.g., noise canceling earphones) so that when audio is played after receiving an alert notification, a single user is alerted audibly instead of playing the audio via the display device's 104 speakers.

The server 106 may include a group of one or more servers. For example, all or some of the operations executed by the computing device 101 may be executed in a different one or a plurality of electronic devices (e.g., the sensor devices 102, the electronic devices 108, and/or the server 106). In an example, if the computing device 101 needs to perform a certain function or service either automatically or based on a request, the computing device 101 may request at least some parts of functions related thereto alternatively or additionally to a different electronic device (e.g., the sensor devices 102, the electronic devices 108, and/or the server 106) instead of executing the function or the service autonomously. The different electronic devices (e.g., the sensor devices 102, the electronic devices 108, and/or the server 106) may execute the requested function or additional function, and may deliver a result thereof to the computing device 101. The computing device 101 may provide the requested function or service either directly or by additionally processing the received result. For example, a cloud computing, distributed computing, or client-server computing technique may be used.

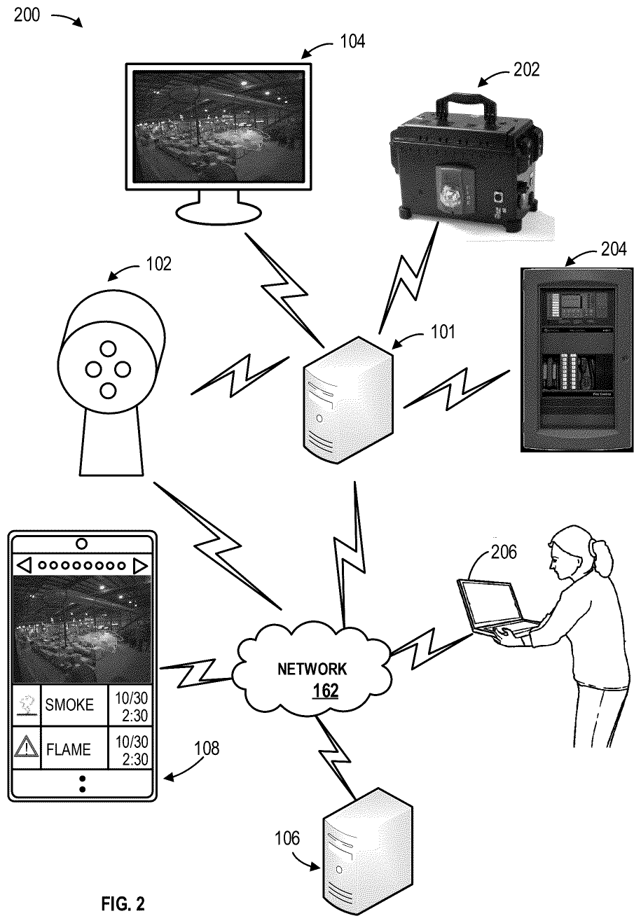

FIG. 2 shows an example system environment 200. The system 200 may comprise the computing device 101, the one or more sensor devices 102, the display device 104, the server 106, the one or more electronic devices 108, the one or more output devices 202, 204, and a remote device 206. The computing device 101 may be in communication with the one or more sensor devices 102, the display device 104, the server 106, the one or more electronic devices 108, and the remote device 202 via network 162. In addition, the computing device 101 may be in communication with the display device 102 and the output devices 202, 204 via a short-range connection (e.g., wired connection, Bluetooth, near-field communicate (NFC), etc.). The computing device 101 may receive data (e.g., IR images, video streams, etc.) captured by the one or more sensor devices 102 of an environment and process/analyze the data to determine one or more hazardous events. The environment may comprise one or more hot activities (e.g., drilling, cutting, grinding, welding, soldering, burning, melting of flammable substances, other spark-producing activities, and the like). The one or more hazardous events may comprise one or more of smoke, flames, visible vapor, steam, oil mist, oil leaks, fuel leaks, reflected flames, explosions, fireballs, motion, and the like. Based on determining the one or more hazardous events, the computing device 101 may output one or more indications associated with the one or more hazardous events. In an example, the computing device 101 may output one or more notifications of the one or more hazardous events to the display device 104, the one or more electronic devices 108, and/or the remote device 206. In another example, the output devices 202 may comprise one or more audio devices and/or lighting devices, wherein the computing device 101 may output the indications to the output devices 202 causing the output devices 202 to output warning signals (e.g., audio signal such as alarm sound and/or lighting signals such as flashing lights) associated with the one or more hazardous events. In another example, the output device 204 may comprise a fire alarm control panel, wherein the computing device 101 may be configured to interface with the fire alarm control panel to control a fire alarm system of a building to output the warning signals associated with the one or more hazardous events. In another example, the computing device 101 may output one or more images associated with the hazardous events, hazardous event information associated with each hazardous event, and/or information associated with the captured data to the display device 104, the one or more electronic devices 108, and/or the remote device 206. The display device 104, the one or more electronic devices 108, and/or the remote device 206 may display the one or more images, the hazardous event information, and/or the information associated with the captured data to one or more users. The hazardous event information may comprise one or more of an indication of each hazardous event of the one or more hazardous events (e.g., identification of the hazardous event) or location information associated with each hazardous event (e.g., a building, a location within the building, a camera that made the detection, etc.). The information associated with the captured data may comprise one or more of a start time, a stop time, a duration, an image, an age, or a location. For example, the one or more images may be overlaid with the hazardous event information and/or the information associated with the captured data. In an example, the remote device 206 may be configured to remotely operate the computing device 101 for controlling the process of receiving and analyzing the data (e.g., IR data and/or images/videos) received by the computing device 101 from the one or more sensor devices 102.

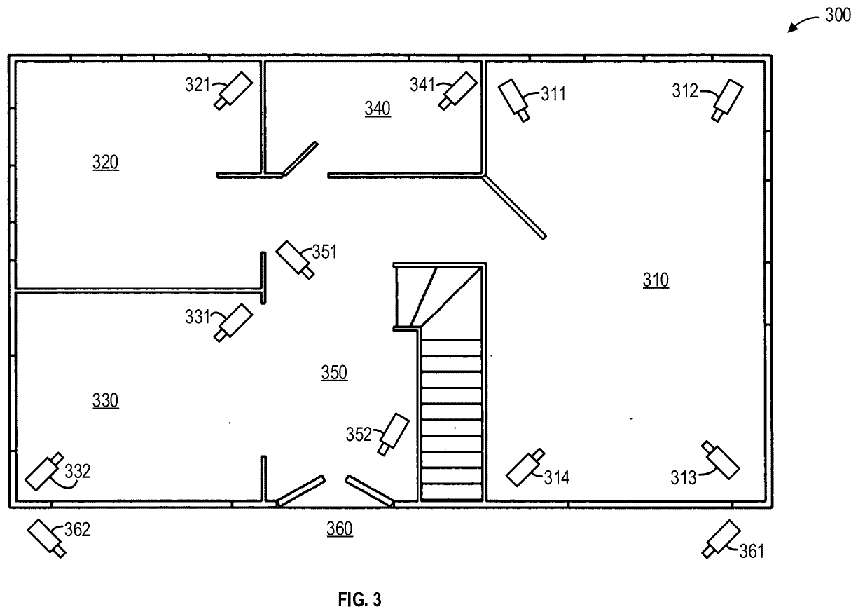

FIG. 3 shows an example system environment 300. As an example, the system 300 may comprise a plurality of sensor devices 311-314, 321, 331-332, 341, 351-352, and 361-362 placed in one or more areas/locations/rooms 310, 320, 330, 340, 350, and 360 associated with a building. For example, as shown in FIG. 3, a first area 310 may include sensor devices 311-314, a second area 320 may include sensor device 321, a third area 330 may include sensor devices 331-332, a fourth area 340 may include sensor device 341, a fifth area 350 may include sensor devices 351-352, and a sixth area 360 (external to the building) may include sensor devices 361-362. A computing device (e.g. computing device 101) may be in communication with the plurality of sensor devices 311-314, 321, 331-332, 341, 351-352, and 361-362 for receiving the data feeds (e.g., IR data, images, video streams, etc.) and/or alert notifications (e.g., indications of detected hazardous events) from the plurality of sensor devices 311-314, 321, 331-332, 341, 351-352, and 361-362. As an example, if sensor devices 331 and 332 detect a hazardous event, the sensor devices 331 and 332 may output one or more images associated with the hazardous event and information (e.g., start time, stop time, duration, image, age, or location) associated with the data. For example, the information associated with the data may include information indicative of the area/location 330 of the sensor devices 331 and 332.

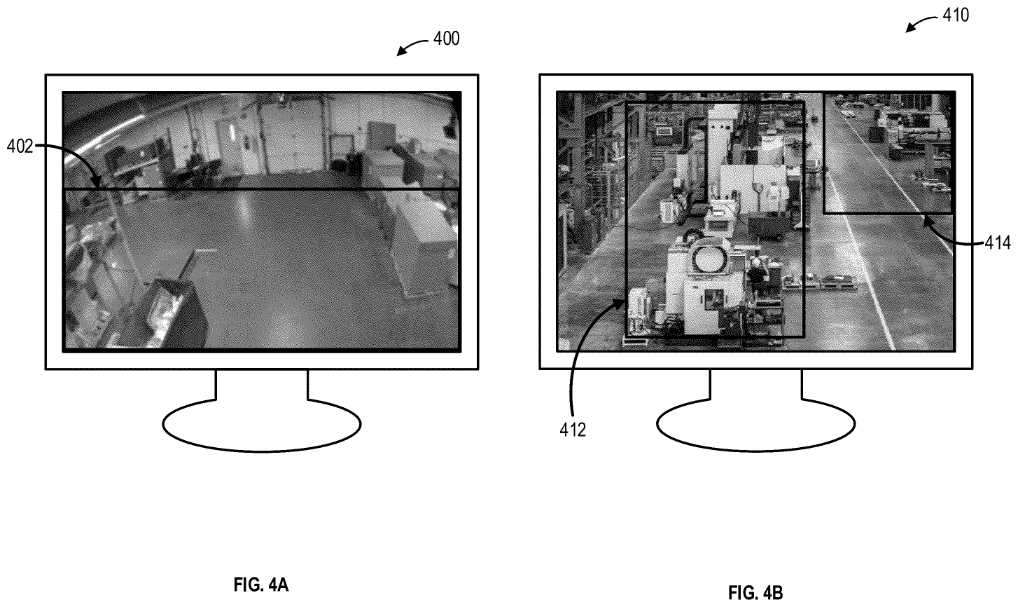

FIGS. 4A-FIG. 7 show examples user interfaces associated with an environment captured by one or more sensor devices (e.g., the one or more sensor devices 102). FIG. 4A shows an example user interface 400 that may be configured for setting a detection zone 402 for detecting smoke in an environment. For example, a user may provide input to set the detection zone 402 as show in FIG. 4A. A computing device (e.g., computing device 101) in communication with the one or more sensor devices may determine that smoke is in the environment if smoke is detected above the top most horizontal line of detection zone 402. Based on detecting the smoke above the top horizontal line of the detection zone 402, the computing device may output an indication of the detected smoke (e.g., notifications, warning signals, one or more images associated with the detected smoke, etc.). FIG. 4B shows an example user interface 410 that may be configured for setting detection zones 412 and 414. As an example, hot work activities may be occurring in an area of the image, wherein a user may not want to enable smoke detection because the hot work activities may cause the computing device generate false alarms based on detecting the hot work activities. For example, if one or more hot work activities are occurring in detection zone 412, the user may provide input to set the detection zone 412 to only detect other hazardous events such as flames or fires. However, the user may provide input to set the detection zone 414 to detect both smoke and flames/fires since hot work may not be occurring in the detection zone 414.

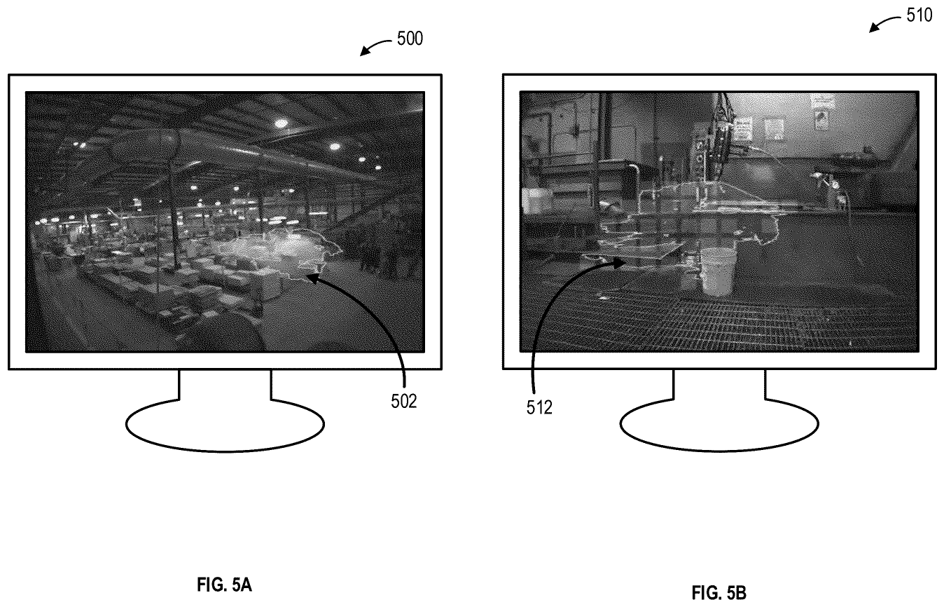

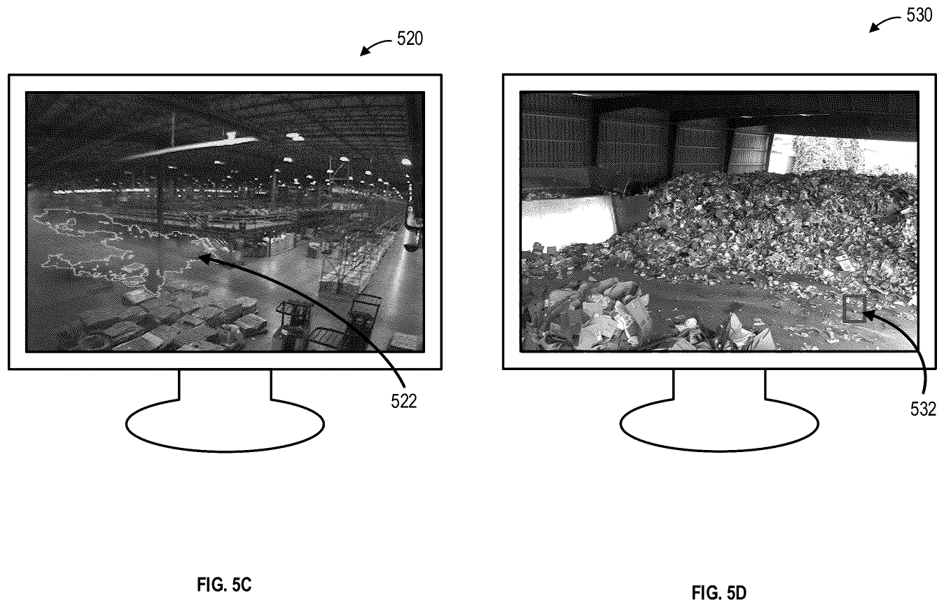

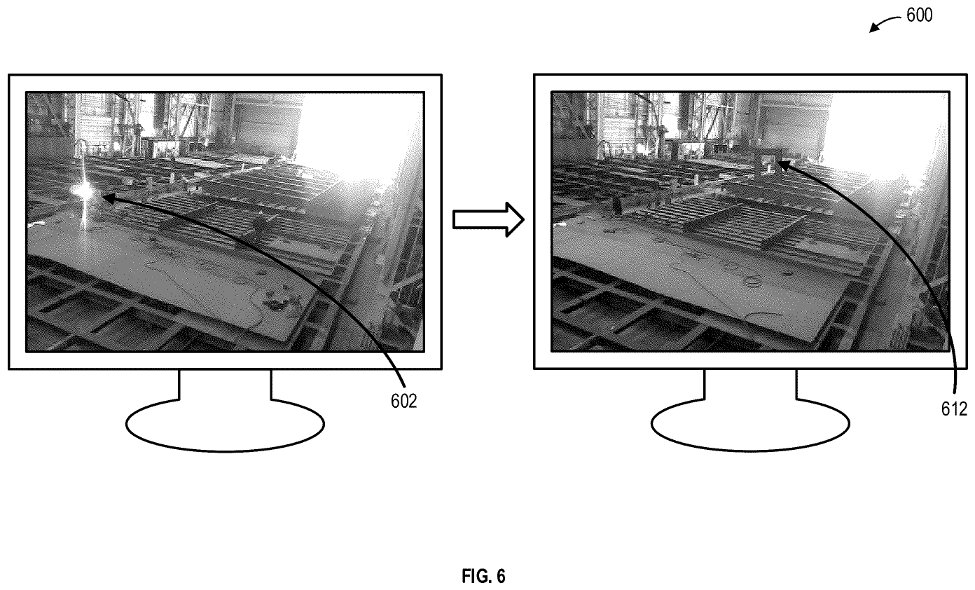

FIGS. 5A-5D show example user interfaces configured for outputting/displaying detections of hazardous events. FIG. 5A shows an example user interface 500 associated with the detection 502 of smoke and flames in an environment. As an example, when a hazardous event is detected, an indication of the detection may be displayed. As shown in FIG. 5A, an outline of the detection 502 may be overlaid onto the image associated with the hazardous event. The outline of the detection 502 overlaid onto the image may be output with the information (e.g., image information) associated with the data captured of the environment and hazardous event information (e.g., indication of the hazardous event and/or location information of the hazardous event) associated with the detected hazardous event. FIG. 5B shows an example user interface 510 associated with the detection 512 of oil mist in an environment. As shown in FIG. 5B, an outline of the detection 512 may be overlaid onto the image indicating the location of the oil mist in the image. FIG. 5C shows an example user interface 520 associated with the detection 522 of smoke in an environment. As shown in FIG. 5C, an outline of the detection 522 may be overlaid onto the image indicating the location of the smoke in the image. FIG. 5D shows an example user interface 530 associated with the detection 532 of a flame source in an environment. As shown in FIG. 5D, an outline of the detection 532 may be overlaid onto the image indicating the location of the flame source in the image.

FIG. 6 show an example user interface 600 wherein the computing device (e.g., computing device 101) and/or the sensor devices (e.g., sensor devices 102) may differentiate between heat sources from hot work activities (e.g., welding and/or mechanical cutting) and flames. For example, as shown in FIG. 6, the user interface 600 displays a hot work activity 602 occurring in the captured environment. However, the hot work activity does not trigger a detection of a hazardous event. Instead, the computing device and the sensor devices continue to monitor the environment until a flame 612 is detected. As an example, an indication of the detected flame may be output with hazardous event information associated with the flame and image information associated with the images associated with the detected flame.

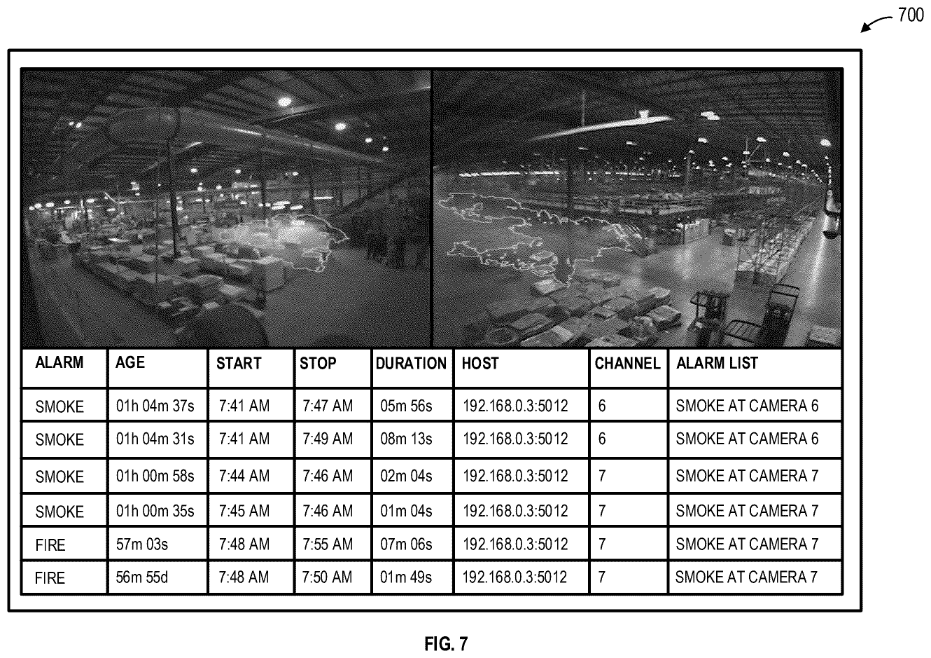

FIG. 7 shows an example user interface 700 displaying two images from different sensor devices (e.g., sensor devices 102) of the same environment (e.g., an area in a building). As shown in FIG. 7, since the sensor devices are placed in different locations, the sensor devices capture images of the environment from the different locations. Based on a detection of one or more hazardous events, indications of the detected one or more hazardous events may be output and displayed via a user interface such as user interface 700. As shown in FIG. 7, each image may be overlaid with an outline indicating the location of the one or more hazardous events in each image. In addition, hazardous event information and image information may be displayed via the user interface. As an example, the hazardous event information and the image information may be displayed below the images associated with the detected one or more hazardous events. The hazardous event information and the image information may include an indication of the detected hazardous event such as smoke and flame detections, as shown in FIG. 7. In addition, ages of the detections (e.g., duration since the detection), start and stop times of the detections, and durations of the detections may be displayed, as shown in FIG. 7. An identifier associated with a host computing device (e.g., the computing device that receives the images and image information from the sensor devices) and identifiers of the sensor devices that captured the images associated with the detected one or more hazardous events, as shown in FIG. 7.

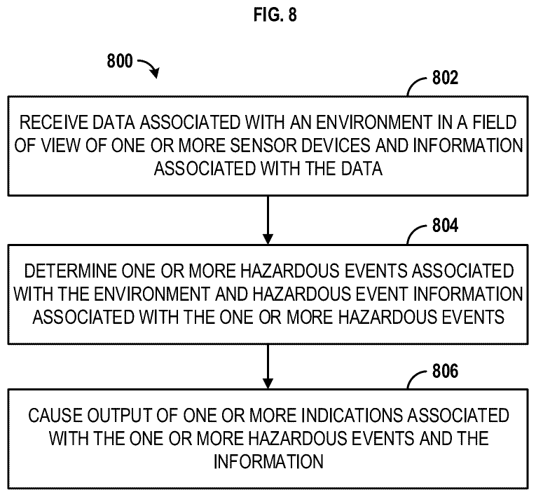

FIG. 8 shows a flowchart of an example method 800 for receiving and analyzing data captured by one or more sensor devices associated with an environment and determining one or more hazardous events in the environment based on analyzing the data. Method 800 may be implemented, for example, by the computing device 101, the sensor devices 102, the display device 104, the electronic devices 108, the output devices 109, and/or the server 106, or one or more combinations thereof. At step 802, data associated with an environment in a field of view of the one or more sensor devices and information associated the data may be received. For example, a computing device (e.g., computing device 101) may receive the data associated with the environment in the field of view of the one or more sensor devices and the information associated with the data from the one or more sensor devices (e.g., sensor devices 102). The one or more sensor devices may comprise one or more of one or more camera devices or one or more infrared detection devices. The data may comprise one or more of infrared data, one or more images, or one or more video streams of the environment in the field of view of the one or more first sensor devices. As an example, each sensor device of the one or more sensor devices may comprise an infrared detection device included (e.g., embedded) with a camera data, wherein the infrared detection device may capture infrared data of the environment and the camera device may capture images/video of the environment. The environment may comprise one or more hot work activities (e.g., drilling, cutting, grinding, welding, soldering, burning, melting of flammable substances, other spark-producing activities, and the like). The field of view may comprise a 90-degree horizontal field of view and a 75-degree vertical field of view from a nose of the one or more sensor devices. The information associated with the data may comprise one or more of a start time, a stop time, a duration, an image, an age (e.g., duration of time since image was captured), or a location.

At step 804, one or more hazardous events associated with the environment and hazardous event information associated with the one or more hazardous events may be determined based on the data. For example, the computing device (e.g., computing device 101) may determine the one or more hazardous events associated with the environment and the hazardous event information associated with the one or more hazardous events based on the data. The one or more hazardous events may comprise one or more of smoke, flames, visible vapor, steam, oil mist, oil leaks, fuel leaks, reflected flames, explosions, fireballs, motion, and the like. The hazardous event information may comprise one or more of an indication of each hazardous event of the one or more hazardous events or location information associated with each hazardous event. In an example, one or more images before each hazardous event of the one or more hazardous events and one or more images after each hazardous event may be determined based on the determination of the one or more hazardous events. The one or more images before each hazardous event may be associated with a preset time interval before each hazardous event and the one or more images after each hazardous event may be associated with a preset time interval after each hazardous event. In an example, one or more detection zones associated with each image of one or more images captured of the environment for detecting the one or more hazardous events may be determined. Determining the one or more hazardous events associated with the environment and the hazardous event information associated with the one or more hazardous events may comprise detecting a hazardous event associated with at least one detection zone of the one or more detection zones associated with at least one image of the one or more images. In an example, determining the one or more hazardous events associated with the environment and the hazardous event information associated with the one or more hazardous events may comprise determining the one or more hazardous events associated with the environment and the hazardous event information associated with the one or more hazardous events based on an application of one or more machine learning models to one or more images captured of the environment. In an example, infrared characteristics of one or more flames in the environment may be identified based on the data. The one or more hazardous events associated with the environment and the hazardous event information associated with the one or more hazardous events may be determined based on the identification of the infrared characteristics (e.g., spectral emissions) of one or more flames.

At step 806, one or more indications associated with the one or more hazardous events and the information may be output based on the determination of the one or more hazardous events. For example, the computing device (e.g., computing device 101) may cause the output of the one or more indications associated with the one or more hazardous events and the information based on the determination of the one or more hazardous events. As an example, the one or more indications associated with the one or more hazardous events may comprise one or more notifications of the one or more hazardous events. In an example, causing the output of the one or more indications associated with the one or more hazardous events and the information based on the determination of the one or more hazardous events may comprise causing output of one or more images associated with the hazardous events, the hazardous event information, and the information based on the determination of the one or more hazardous events. As an example, the one or more images may be overlaid with the hazardous event information and the information associated with the one or more hazardous events. In an example, one or more of the one or more indications associated with the one or more hazardous events, the information, or the one or more images associated with the one or more hazardous events may be sent/output to a user device. For example, the computing device (e.g., computing device 101) may send/output one or more of the one or more indications associated with the one or more hazardous events, the information, or the one or more images associated with the one or more hazardous events to the user device (e.g., electronic device 108), wherein the user device may display the one or more indications associated with the one or more hazardous events, the information, and/or the one or more images.

While the methods and systems have been described in connection with specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. An apparatus comprising:
one or more sensor devices configured to:
capture data associated with an environment in a field of view of the one or more sensor devices, and
output the data associated with the environment in the field of view of the one or more sensor devices and information associated with the data; and
a computing device in communication with the one or more sensor devices, wherein the computing device is configured to:
receive the data associated with the environment in the field of view of the one or more sensor devices and the information associated with the data,
determine, based on the data, one or more hazardous events associated with the environment and hazardous event information associated with the one or more hazardous events, and
cause, based on the determination of the one or more hazardous events, output of one or more indications associated with the one or more hazardous events and the information.

2. The apparatus of claim 1, wherein the one or more sensor devices comprise one or more of one or more camera devices or one or more infrared detection devices and the data comprises one or more of infrared data, one or more images, or one or more video streams of the environment in the field of view of the one or more sensor devices.

3. The apparatus of claim 1, wherein the information comprises one or more of a start time, a stop time, a duration, an image, an age, or a location and the hazardous event information comprises one or more of an indication of each hazardous event of the one or more hazardous events or location information associated with each hazardous event.

4. The apparatus of claim 1, wherein the one or more hazardous events comprise one or more of smoke, flames, visible vapor, steam, oil mist, oil leaks, fuel leaks, reflected flames, explosions, fireballs, or motion.

5. The apparatus of claim 1, wherein the computing device is further configured to determine, based on the determination of the one or more hazardous events, one or more images before each hazardous event of the one or more hazardous events and one or more images after each hazardous event.

6. The apparatus of claim 1, wherein the computing device is configured to determine, based on the data, the one or more hazardous events associated with the environment and the hazardous event information associated with the one or more hazardous events, the computing device is further configured to:
determine one or more detection zones associated with each image of one or more images for detecting the one or more hazardous events, and
detect a hazardous event associated with at least one detection zone of the one or more detection zones associated with at least one image of the one or more images.

7. The apparatus of claim 1, wherein the computing device is configured to determine, based on data, the one or more hazardous events associated with the environment and the hazardous event information associated with the one or more hazardous events, the computing device is further configured to:
determine, based on an application of one or more machine learning models to one or more images, the one or more hazardous events associated with the environment and the hazardous event information associated with the one or more hazardous events.

8. The apparatus of claim 1, wherein the computing device is configured to determine, based on data, the one or more hazardous events associated with the environment and the hazardous event information associated with the one or more hazardous events, the computing device is further configured to:
identify, based on the data, infrared characteristics of one or more flames in the environment; and
determine, based on the identification of the infrared characteristics of one or more flames, the one or more hazardous events associated with the environment and the hazardous event information associated with the one or more hazardous events.

9. The apparatus of claim 1, wherein the computing device is configured to cause, based on the determination of the one or more hazardous events, the output of the one or more indications associated with the one or more hazardous events, the computing device is further configured to:
cause, based on the determination of the one or more hazardous events, output of one or more images associated with the one or more hazardous events, the hazardous event information, and the information.

10. The apparatus of claim 1, further comprising one or more batteries configured to provide DC power to a power system, wherein the power system is configured to:
receive the DC power from the one or more batteries,
receive AC power from an external power source, and
providing one or more of the AC power or the DC power to the one or more sensor devices and the computing device.

11. The apparatus of claim 1, further comprising one or more second sensor devices affixed to the one or more sensor devices, wherein the one or more second sensor devices are configured to:
determine one or more indications of tampering associated with the one or more sensor devices, and
output one or more notifications associated with the one or more indications of tampering associated with the one or more sensor devices.

12. A method comprising:
receiving, by a computing device, from one or more sensor devices, data associated with an environment in a field of view of the one or more sensor devices and information associated with the data;
determining, based on the data, one or more hazardous events associated with the environment and hazardous event information associated with the one or more hazardous events; and
causing, based on the determination of the one or more hazardous events, output of one or more indications associated with the one or more hazardous events and the information.

13. The method of claim 12, wherein the one or more sensor devices comprise one or more of one or more camera devices or one or more infrared detection devices and the data comprises one or more of infrared data, one or more images, or one or more video streams of the environment in the field of view of the one or more sensor devices.

14. The method of claim 12, wherein the information comprises one or more of a start time, a stop time, a duration, an image, an age, or a location and the hazardous event information comprises one or more of an indication of each hazardous event of the one or more hazardous events or location information associated with each hazardous event.

15. The method of claim 12, wherein the one or more hazardous events comprise one or more of smoke, flames, visible vapor, steam, oil mist, oil leaks, fuel leaks, reflected flames, explosions, fireballs, or motion.

16. The method of claim 12, further comprising determining, based on the determination of the one or more hazardous events, one or more images before each hazardous event of the one or more hazardous events and one or more images after each hazardous event.

17. The method of claim 12, wherein determining, based on the data, the one or more hazardous events associated with the environment and the hazardous event information associated with the one or more hazardous events comprises:
determining one or more detection zones associated with each image of one or more images for detecting the one or more hazardous events, and
detecting a hazardous event associated with at least one detection zone of the one or more detection zones associated with at least one image of the one or more images.

18. The method of claim 12, wherein determining, based on the data, the one or more hazardous events associated with the environment and the hazardous event information associated with the one or more hazardous events comprises:
determining, based on an application of one or more machine learning models to one or more images, the one or more hazardous events associated with the environment and the hazardous event information associated with the one or more hazardous events.

19. The method of claim 12, wherein determining, based on the data, the one or more hazardous events associated with the environment and the hazardous event information associated with the one or more hazardous events comprises:
identifying, based on the data, infrared characteristics of one or more flames in the environment; and
determining, based on the identification of the infrared characteristics of one or more flames, the one or more hazardous events associated with the environment and the hazardous event information associated with the one or more hazardous events.

20. The method of claim 12, wherein causing, based on the determination of the one or more hazardous events, the output of the one or more indications associated with the one or more hazardous events and the information comprises:
causing, based on the determination of the one or more hazardous events, output of one or more images associated with the one or more hazardous events, the hazardous event information, and the information.
